(19) United States
(12) Patent Application Publication
(10) Pub. No.: US 2015/0340944 A1
(43) Pub. Date: Nov. 26, 2015

(54) LIGHT EMITTING DEVICE DRIVER CIRCUIT, CURRENT RIPPLE REJECTER THEREIN, AND CURRENT RIPPLE REJECTION METHOD THEREFOR

(71) Applicants: Tzu-Chen Lin, Tianzhong Township (TW); Chang-Yu Wu, Zhubei City (TW); Isaac Y. Chen, Zhubei City (TW)

(72) Inventors: Tzu-Chen Lin, Tianzhong Township (TW); Chang-Yu Wu, Zhubei City (TW); Isaac Y. Chen, Zhubei City (TW)

(73) Assignee: RICHTEK TECHNOLOGY CORPORATION, Zhubei City (TW)

(21) Appl. No.: 14/706,915

(22) Filed: May 7, 2015

Related U.S. Application Data
(60) Provisional application No. 62/002,324, filed on May 23, 2014.

(51) Int. Cl. H02M 1/14; H05B 37/02

(52) U.S. Cl. CPC H02M 1/14; H05B 37/02

(57) ABSTRACT

The present invention discloses a light emitting device driver circuit, a current ripple rejecter therein, and a current ripple rejection method therefor. The light emitting device driver circuit includes: a power converter circuit, for converting an input voltage carrying an AC component to an output voltage and supplying an output current; and a current ripple rejecter, which is coupled to the power converter circuit, for filtering a ripple of the output current to generate a light emitting device current, and supplying the light emitting device current to a light emitting device circuit. The current ripple rejecter includes: a low-pass-filter circuit, for filtering the ripple of the output current to generate a filtered current; and a current amplification circuit, which is coupled to the low-pass-filter circuit, for amplifying the filtered current to generate an amplified current; wherein the light emitting device current includes the amplified current.

### CROSS REFERENCE

The present invention claims priority to U.S. 62/002,324, filed on May 23, 2014.

### BACKGROUND OF THE INVENTION

1. Field of Invention

The present invention relates to a light emitting device driver circuit, a current ripple rejecter therein, and a current ripple rejection method therefor; particularly, it relates to such light emitting device driver circuit, current ripple rejecter therein, and current ripple rejection method therefor, which filter a ripple of an output current so as to supply a light emitting device current with less ripple to a light emitting device circuit.

2. Description of Related Art

FIG. 1 shows a schematic diagram of a prior art light emitting device driver circuit. As shown in FIG. 1, a power converter circuit 101 converts an input voltage Vin which carries an AC component to an output voltage Vout, and supplies an output current Iout as a light emitting device current Iled to a light emitting diode (LED) circuit 10. In a typical case, the power converter circuit 101 is a single-stage power converter circuit with a power factor correction (PFC) function. The “single-stage” power converter circuit refers to the case wherein an AC/DC converter circuit converts an AC voltage to a DC voltage and supplies a DC current to the LED circuit 10, wherein only one power stage is involved. In contrast, a “two-stage” power converter circuit refers to the case that an AC/DC converter circuit converts an AC voltage to a DC voltage, and a DC/DC converter circuit supplies a DC current to the LED circuit 10 according to the DC voltage, wherein two power stages are involved.

In comparison to the two-stage power converter circuit, the DC current generated by the single-stage power converter circuit has an obvious ripple. The ripple causes a flicker of the LED circuit 10; the brightness will vary periodically in twice frequency of the AC voltage. The flicker may not be perceived by naked eyes, but will affect the image captured by a camera or image sensor device.

In view of above, for mitigating the flicker, the present invention proposes a light emitting device driver circuit, a current ripple rejecter therein, and a current ripple rejection method therefor, which filter the ripple of the output current so as to supply the light emitting device current with less ripple to the light emitting device circuit.

### SUMMARY OF THE INVENTION

From one perspective, the present invention provides a light emitting device driver circuit, including: a power converter circuit, for converting an input voltage carrying an AC component to an output voltage and supplying an output current; and a current ripple rejecter, which is coupled to the power converter circuit, for filtering a ripple of the output current to generate a light emitting device current which is supplied to a light emitting device circuit, the current ripple rejecter including: a low-pass-filter circuit, which is coupled to the power converter circuit, for filtering the ripple of the output current to generate a filtered current; and a current amplification circuit, which is coupled to the low-pass-filter circuit, for amplifying the filtered current to generate an amplified current; wherein the light emitting device current includes the amplified current.

From another perspective, the present invention provides a current ripple rejecter in a light emitting device driver circuit, wherein the current ripple rejecter is coupled to a power converter circuit which converts an input voltage carrying an AC component to an output voltage and supplying an output current, and the current ripple rejecter is for filtering a ripple of the output current to generate a light emitting device current which is supplied to a light emitting device circuit, the current ripple rejecter including: a low-pass-filter circuit, which is coupled to the power converter circuit, for filtering the ripple of the output current to generate a filtered current; and a current amplification circuit, which is coupled to the low-pass-filter circuit, for amplifying the filtered current to generate an amplified current; wherein the light emitting device current includes the amplified current.

In one preferable embodiment, the current ripple rejecter is connected between the power converter circuit and the light emitting device circuit.

In one preferable embodiment, the light emitting device circuit is connected between the power converter circuit and the current ripple rejecter.

Preferably, the low-pass-filter circuit includes a resistor and a capacitor connected in series; the current amplification circuit includes a bipolar junction transistor (BJT) having a base which is coupled between the resistor and the capacitor, and the current amplification circuit generates the amplified current according to a base current flowing through the base.

In one preferable embodiment, the current amplification circuit includes a current mirror circuit, for mirroring and amplifying the filtered current to generate the amplified current.

From another perspective, the present invention provides a current ripple rejection method for a light emitting device driver circuit, including: converting an input voltage which carries an AC component to an output voltage, and supplying an output current; filtering a ripple of the output current to generate a filtered current; amplifying the filtered current to generate an amplified current; generating a light emitting device current according to the amplified current, wherein the light emitting device current is supplied to a light emitting device circuit, and wherein the light emitting device current includes the amplified current.

The objectives, technical details, features, and effects of the present invention will be better understood with regard to the detailed description of the embodiments below.

### BRIEF DESCRIPTION OF THE DRAWINGS

FIG. 1 shows a schematic diagram of a prior art light emitting device driver circuit.

FIG. 2 shows a first embodiment of the present invention.

FIG. 3 shows a second embodiment of the present invention.

FIG. 4 shows a third embodiment of the present invention.

FIG. 5 shows a fourth embodiment of the present invention.

FIG. 6 shows a fifth embodiment of the present invention.

FIG. 7 shows a sixth embodiment of the present invention.

FIGS. 8A and 8B show schematic diagrams of signal waveforms of light emitting device currents of the prior art and the present invention.

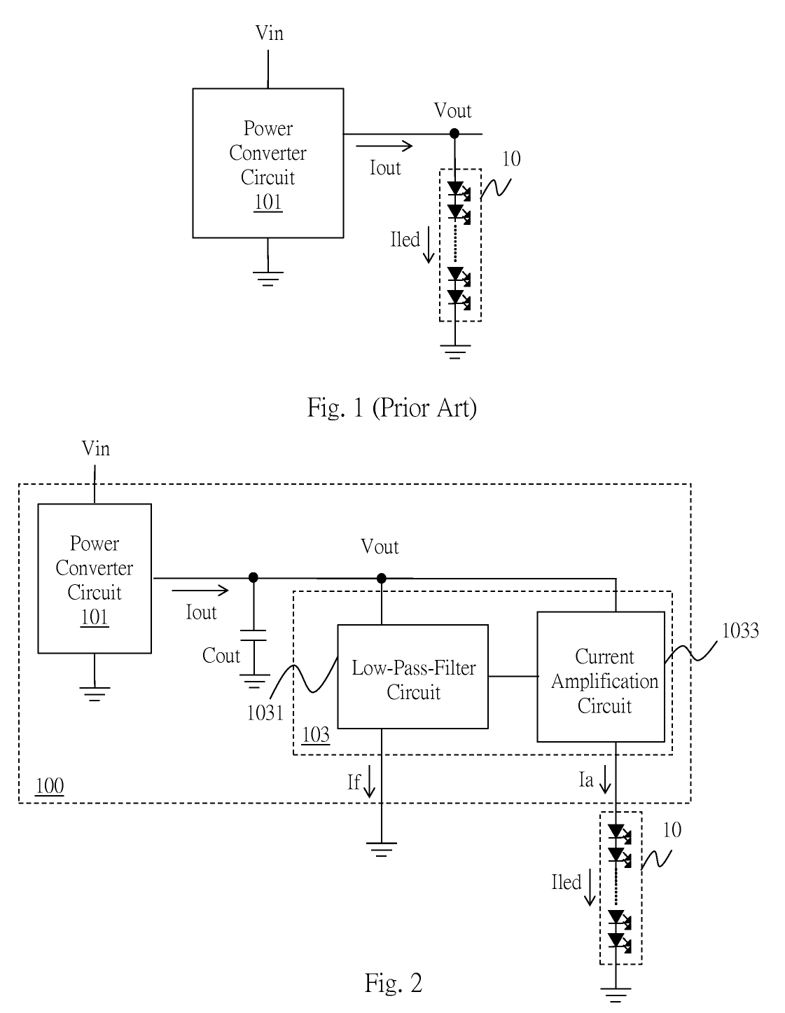

### DESCRIPTION OF THE PREFERRED EMBODIMENTS

Please refer to FIG. 2 for a first embodiment according to the present invention. As shown in FIG. 2, a light emitting device driver circuit 100 includes a power converter circuit 101 and a current ripple rejecter 103. The power converter circuit 101 converts an input voltage Vin which carries an AC component to an output voltage Vout, and supplies an output current Iout. In one embodiment, the power converter circuit 101 is for example a single-stage power converter circuit with a PFC function, and supplies a constant output current Iout. The current ripple rejecter 103 is coupled to the power converter circuit 101, for filtering a ripple of the output current Iout, to generate a light emitting device current Iled which is supplied to an LED circuit 10. The current ripple rejecter 103 includes a low-pass-filter circuit 1031 and a current amplification circuit 1033. The low-pass-filter circuit 1031 is coupled to the power converter circuit 101, for filtering the ripple of the output current Iout, to generate a filtered current If. The current amplification circuit 1033 is coupled to the low-pass-filter circuit 1031, for amplifying the filtered current If to generate an amplified current Ia. The light emitting device current Iled includes the amplified current Ia.

In the prior art, referring to the waveform of FIG. 8A, the light emitting device current Iled has an AC component (ripple) and a DC component (the average current). The present invention provides the current ripple rejecter 103, which is coupled to the power converter circuit 101, for filtering the ripple of the output current Iout such that the light emitting device current Iled flowing through the LED circuit 10 has a relatively lower ripple in comparison with the prior art. The current ripple rejecter circuit 103 has a high impedance to the AC component, such that most part of the ripple of the output current Iout flows through the output capacitor Cout (FIG. 2). Therefore, referring to FIG. 8B, the light emitting device current Iled according to the present invention has a relatively lower AC component (ripple).

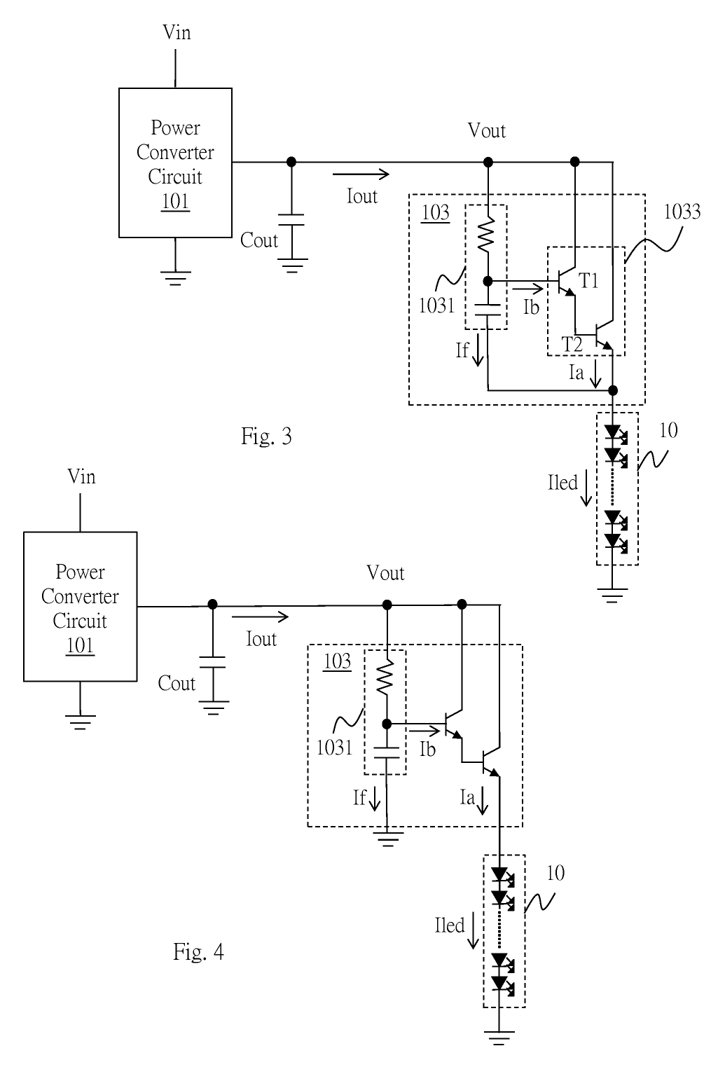

FIG. 3 shows a second embodiment of the present invention. As shown in FIG. 3, the current ripple rejecter circuit 103 is connected between the power converter circuit 101 and the LED circuit 10 in series. This embodiment shows a more specific embodiment of the current ripple rejecter 103. In this embodiment, the current ripple rejecter 103 includes a low-pass-filter circuit 1031 and a current amplification circuit 1033. The low-pass-filter circuit 1031 includes a resistor and a capacitor connected in series. The current amplification circuit 1033 includes a bipolar junction transistor (BJT) circuit. In the BJT circuit, a BJT T1 has a base coupled between the resistor and the capacitor of the low-pass-filter circuit 1031. The current amplification circuit 1033 generates an amplified current Ia according to a base current Ib flowing through the base of the BJT T1. The low-pass-filter circuit 1031 has a high impedance to the AC component, and furthermore, with the filtering function by the capacitor therein, the base current Ib has an extremely low ripple. The BJT T1 amplifies the base current Ib. As shown in the figure, in one embodiment, the low-pass-filter circuit 1031 further includes a transistor T2 coupled to the BJT T1, which further amplifies the base current Ib to generate the amplified current Ia with an extremely low ripple. In this embodiment, as shown in the figure, the light emitting device current Iled includes the filtered current If and the amplified current Ia, and because the current Ia is significantly larger than the filtered current If, the light emitting device current Iled has a relatively low ripple. Note that the transistor T2 may be omitted, or it can be another type of transistor instead of the BJT, such as a metal oxide semiconductor (MOS) device, or the transistor T2 can be replaced by an error amplifier circuit, etc.

FIG. 4 shows a third embodiment of the present invention. This embodiment is different from the second embodiment in that, in this embodiment, the lower end of the low-pass-filter circuit 1031 is connected to ground instead of the LED circuit 10, such that the light emitting device current Iled only includes the amplified current Ia without the filtered current If.

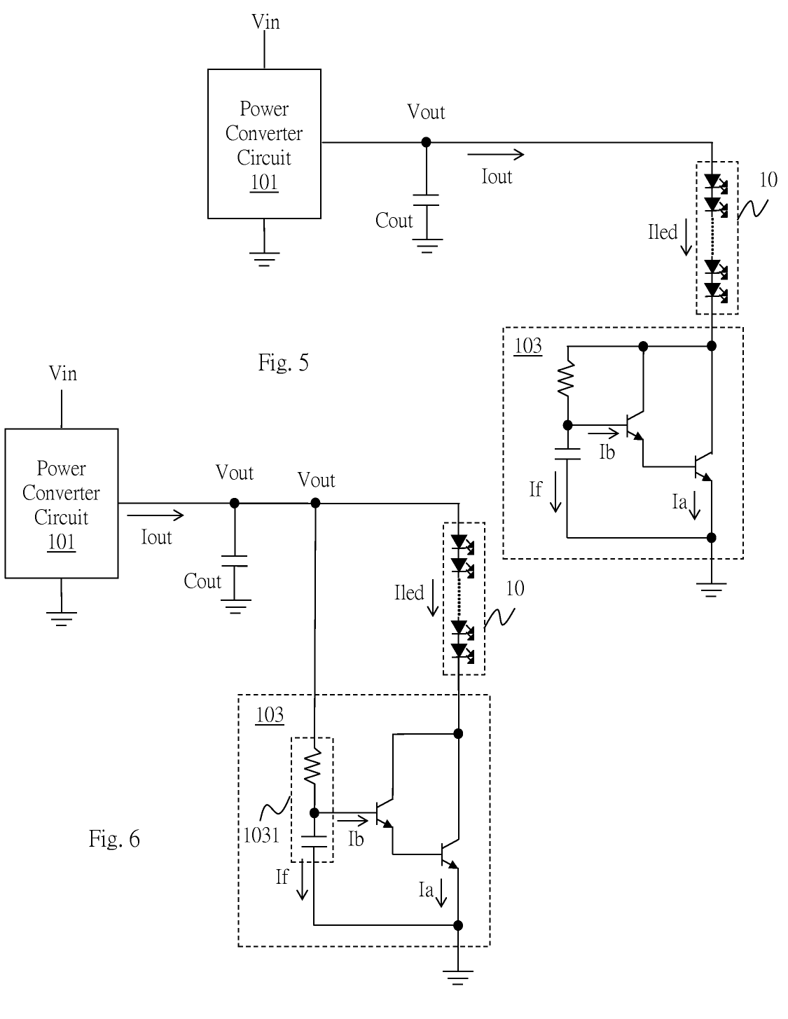

FIG. 5 shows a fourth embodiment of the present invention. This embodiment is different from the second embodiment in that, in this embodiment, as shown in FIG. 5, the LED circuit 10 is connected between the power converter circuit 101 and the current ripple rejecter 103 in series.

FIG. 6 shows a fifth embodiment of the present invention. This embodiment is different from the fourth embodiment in that, in this embodiment, as shown in FIG. 6, the higher end of the low-pass-filter circuit 1031 is connected to power converter circuit 101 instead of the LED circuit 10, such that the light emitting device current Iled only includes the amplified current Ia without the filtered current If.

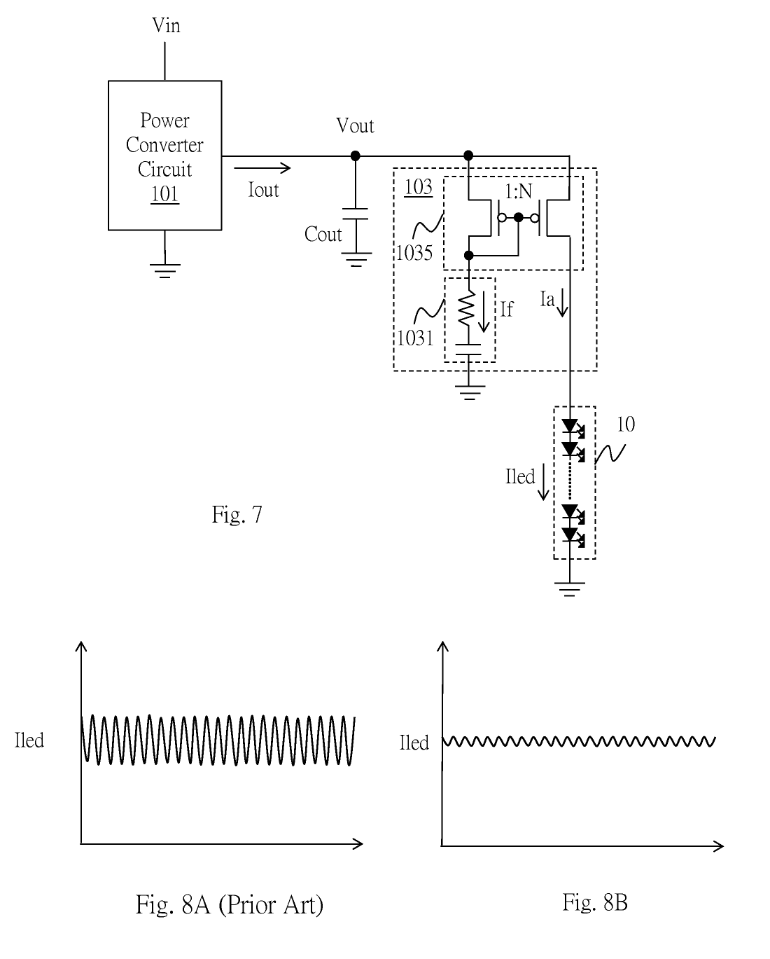

FIG. 7 shows a sixth embodiment of the present invention. As shown in FIG. 7, the current ripple rejecter 103 is connected between the power converter circuit 101 and the LED circuit 10 in series. This embodiment shows another more specific embodiment of the current ripple rejecter 103, which includes the low-pass-filter circuit 1031 and a current mirror circuit 1035. The low-pass-filter circuit 1031 includes the resistor and the capacitor connected in series. The current mirror circuit 1035 for example has an amplification ratio of 1 to N, for mirroring and amplifying the filtered current If to generate the amplified current Ia.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device or circuit which does not substantially influence the primary function of a signal can be inserted between any two devices or circuits in the shown embodiments, so the term “couple” should include direct and indirect connections. For another example, the light emitting devices connected in series can be further connected to other light emitting devices in parallel. For another example, the light emitting device that is applicable to the present invention is not limited to the LED as shown and described in the embodiments above, but may be any light emitting device with a forward terminal and a reverse terminal. In view of the foregoing, the spirit of the present invention should cover all such and other modifications and variations, which should be interpreted to fall within the scope of the following claims and their equivalents.

What is claimed is:

1. A light emitting device driver circuit, comprising:
a power converter circuit, for converting an input voltage carrying an AC component to an output voltage and supplying an output current; and
a current ripple rejecter, which is coupled to the power converter circuit, for filtering a ripple of the output current to generate a light emitting device current which is supplied to a light emitting device circuit, the current ripple rejecter including:
a low-pass-filter circuit, which is coupled to the power converter circuit, for filtering the ripple of the output current to generate a filtered current; and
a current amplification circuit, which is coupled to the low-pass-filter circuit, for amplifying the filtered current to generate an amplified current;
wherein the light emitting device current includes the amplified current.

2. The driver circuit of claim 1, wherein the current ripple rejecter is connected between the power converter circuit and the light emitting device circuit.

3. The driver circuit of claim 1, wherein the light emitting device circuit is connected between the power converter circuit and the current ripple rejecter.

4. The driver circuit of claim 2, wherein the low-pass-filter circuit includes a resistor and a capacitor connected in series; wherein the current amplification circuit includes a bipolar junction transistor (BJT) having a base which is coupled between the resistor and the capacitor, and the current amplification circuit generates the amplified current according to a base current flowing through the base.

5. The driver circuit of claim 3, wherein the low-pass-filter circuit includes a resistor and a capacitor connected in series; wherein the current amplification circuit includes a bipolar junction transistor (BJT) having a base which is coupled between the resistor and the capacitor, and the current amplification circuit generates the amplified current according to a base current flowing through the base.

6. The driver circuit of claim 1, wherein the current amplification circuit includes a current mirror circuit, for mirroring and amplifying the filtered current to generate the amplified current.

7. A current ripple rejecter in a light emitting device driver circuit, wherein the current ripple rejecter is coupled to a power converter circuit which converts an input voltage carrying an AC component to an output voltage and supplying an output current, and the current ripple rejecter is for filtering a ripple of the output current to generate a light emitting device current which is supplied to a light emitting device circuit, the current ripple rejecter comprising:
a low-pass-filter circuit, which is coupled to the power converter circuit, for filtering the ripple of the output current to generate a filtered current; and
a current amplification circuit, which is coupled to the low-pass-filter circuit, for amplifying the filtered current to generate an amplified current;
wherein the light emitting device current includes the amplified current.

8. The current ripple rejecter of claim 7, wherein the current ripple rejecter is connected between the power converter circuit and the light emitting device circuit.

9. The current ripple rejecter of claim 7, wherein the light emitting device circuit is connected between the power converter circuit and the current ripple rejecter.

10. The current ripple rejecter of claim 8, wherein the low-pass-filter circuit includes a resistor and a capacitor connected in series; wherein the current amplification circuit includes a bipolar junction transistor (BJT) having abase which is coupled between the resistor and the capacitor, and the current amplification circuit generates the amplified current according to abase current flowing through the base.

11. The current ripple rejecter of claim 9, wherein the low-pass-filter circuit includes a resistor and a capacitor connected in series; wherein the current amplification circuit includes a bipolar junction transistor (BJT) having abase which is coupled between the resistor and the capacitor, and the current amplification circuit generates the amplified current according to abase current flowing through the base.

12. The current ripple rejecter of claim 7, wherein the current amplification circuit includes a current mirror circuit, for mirroring and amplifying the filtered current to generate the amplified current.

13. A current ripple rejection method for a light emitting device driver circuit, comprising:
converting an input voltage which carries an AC component to an output voltage, and supplying an output current;
filtering a ripple of the output current to generate a filtered current;
amplifying the filtered current to generate an amplified current;
generating a light emitting device current according to the amplified current, wherein the light emitting device current is supplied to a light emitting device circuit, and wherein the light emitting device current includes the amplified current.
